(19) United States
(12) Patent Application Publication
(10) Pub. No.: US 2026/0205813 A1
(43) Pub. Date: Jul. 16, 2026

(54) SPLIT MEDIA ACCESS CONTROL (MAC) FOR AUTOMOTIVE WIRELESS

(71) Applicant: Cisco Technology, Inc., San Jose, CA (US)

(72) Inventors: Domenico Ficara, Essertines-Sur-Yverdon (CH); Ugo Mario Campiglio, Morges (CH); Federico Lovison, Fontanelle (IT); Javier Contreras, Barcelona (ES); Juan Carlos Zuniga, Montreal (CA); Suresh Krishnan, Suwanee, GA (US)

(73) Assignee: Cisco Technology, Inc., San Jose, CA (US)

(21) Appl. No.: 19/446,230

(22) Filed: Jan. 12, 2026

Related U.S. Application Data
(60) Provisional application No. 63/744,025, filed on Jan. 10, 2025.

(51) Int. Cl. H04W 12/08; H04W 12/61

(52) U.S. Cl. CPC H04W 12/08; H04W 12/61

(57) ABSTRACT

Split Media Access Control (MAC) for automotive wireless may be provided. A client device may report a position of the client device to a cloud-based service through an Out-of-Band (OOB) connection. Next the client device may receive, from the cloud-based service, a mapping of services available to the client device. The client device may then communicate according to the mapping of services available to the client device wherein the cloud-based service may implement control-plane functions and the client device may implement data-plane functions.

### RELATED APPLICATION

Under provisions of 35 U.S.C. § 119(e), Applicant claims the benefit of U.S. Provisional Application No. 63/744,025, filed January 10, 2025, which is incorporated herein by reference.

### TECHNICAL FIELD

The present disclosure relates generally to providing split Media Access Control (MAC) for automotive wireless.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices

that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing split Media Access Control (MAC) for automotive wireless;

FIG. 2 is a flow chart of a method for providing split MAC for automotive wireless; and

FIG. 3 is a block diagram of a computing device.

### DETAILED DESCRIPTION

### OVERVIEW

Split Media Access Control (MAC) for automotive wireless may be provided. A client device may report a position of the client device to a cloud-based service through an Out-of-Band (OOB) connection. Next the client device may receive, from the cloud-based service, a mapping of services available to the client device. The client device may then communicate according to the mapping of services available to the client device wherein the cloud-based service may implement control-plane functions and the client device may implement data-plane functions.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11 specification standard may target vehicle connectivity through Wi-Fi (e.g., with the aid of other technologies as well) in scenarios where vehicles may be moving under 40 km/h for example. This may work with diverse and heterogeneous IEEE 802.11 networks that the vehicle may find moving along its path.

Multiple problems may need to be solved for vehicle connectivity through Wi-Fi to be possible. For example, the vehicle may need to establish an “opportunistic” connection to IEEE 802.11 networks around the vehicle. Furthermore, roaming may need to be fast and seamless (e.g., at 40km/h, the vehicle may need to roam every few seconds, hence every few milliseconds may count). In addition, traffic may need to be handled by APs of any deployment, preserving confidentiality and privacy. Accordingly, embodiments of the disclosure may split the control plane and the data plane such that a cloud-based service may establish association and authentication on multiple wireless networks along the road (i.e., path) that a vehicle may go through in order to obtain seamless roaming.

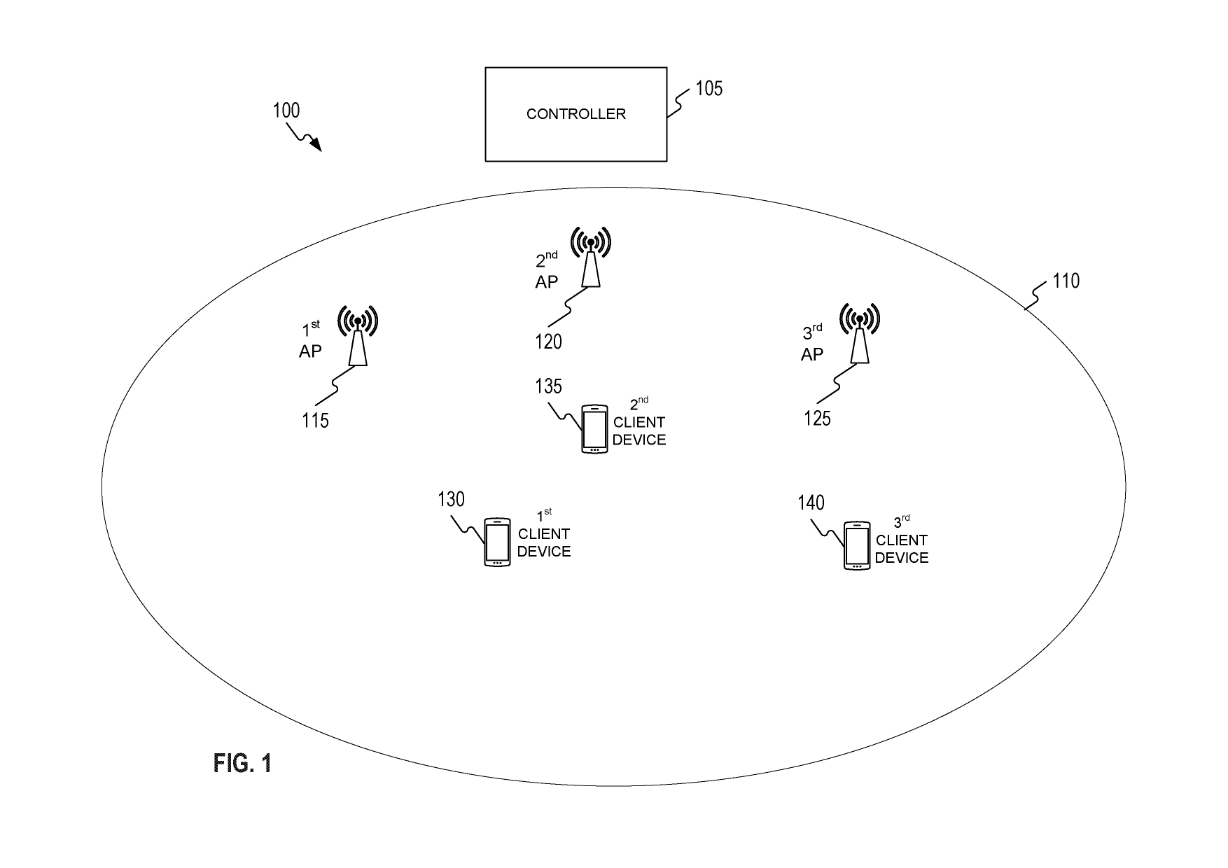

FIG. 1 shows an operating environment 100 for providing split Media Access Control (MAC) for automotive wireless. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an autonomous vehicle, an Unmanned Aerial Vehicle (UAV), Virtual Reality (VR)/Augmented Reality (AR) devices, or other similar microcomputer-based device. Ones of the plurality of client devices may be associated with or comprise a vehicle (autonomous or otherwise) operating on the surface of the Earth on roadways for example. Each of the plurality of APs may be compatible with specification standards such as, but not limited to, the Institute of Electrical and Electronics Engineers (IEEE) 802.11 specification standard.

The plurality of APs and the plurality of client devices may use Multi Link Operation (MLO) where they simultaneously transmit and receive across different bands (or links) and channels by establishing two or more links to two or more AP radios. These bands may comprise, but are not limited to the 2.4 GHz band, the 5 GHz band, the 6GHz band, and the 60GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide split MAC for automotive wireless.

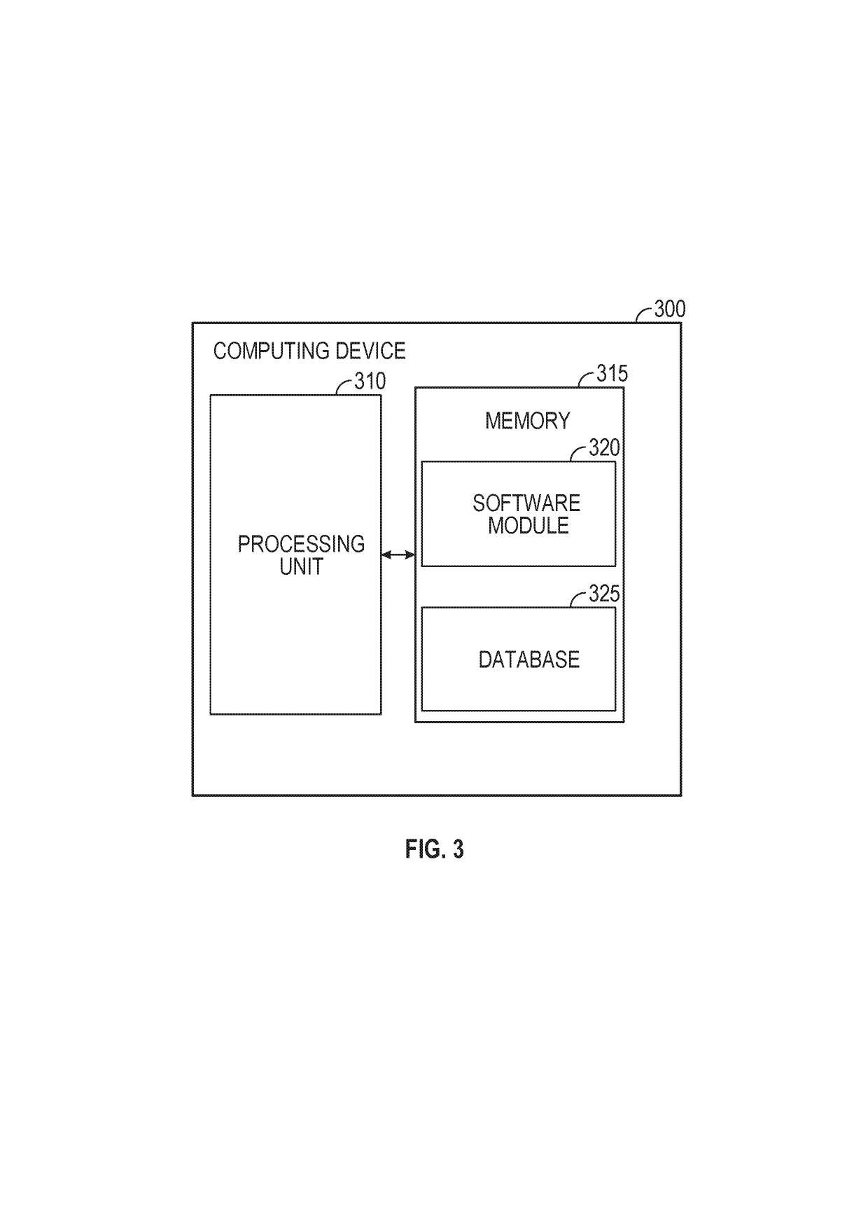

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

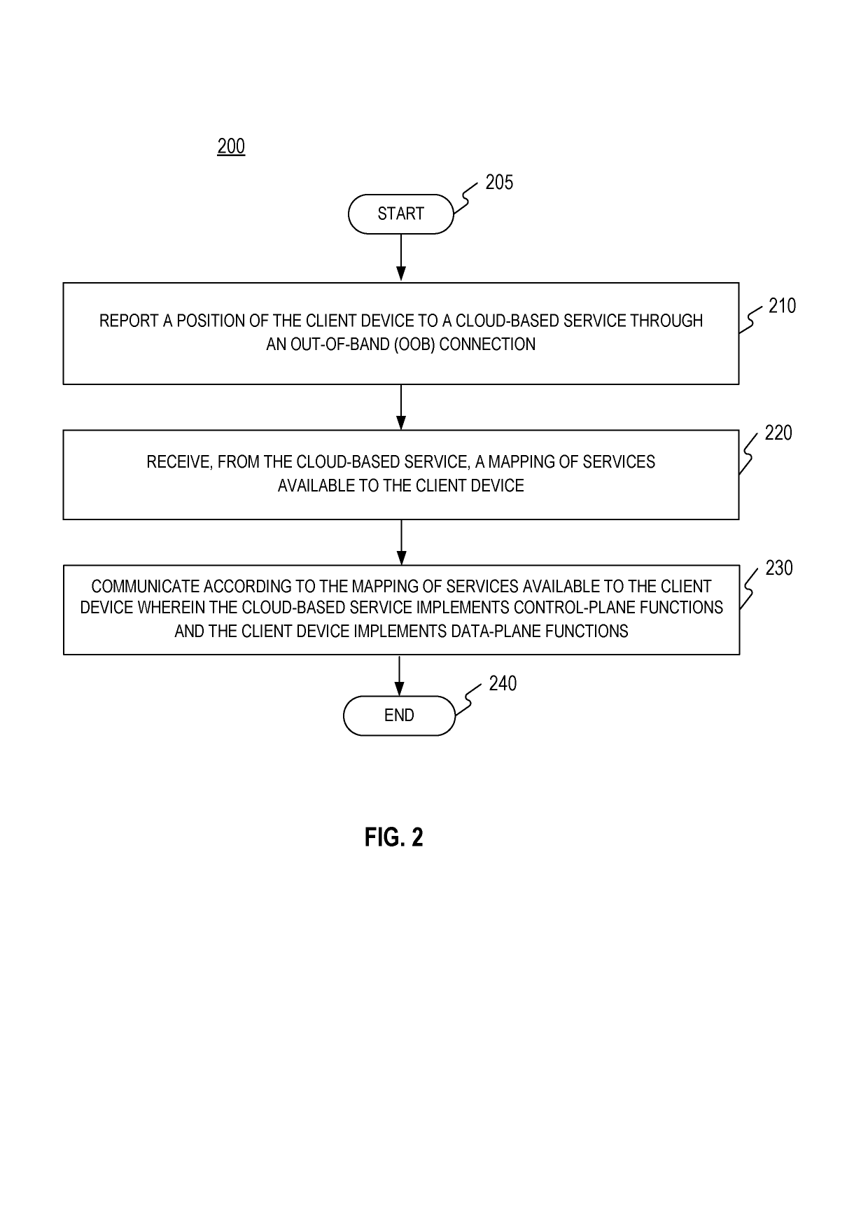

FIG. 2 is a flow chart setting forth the general stages involved in a method 200 consistent with embodiments of the disclosure for providing split MAC for automotive wireless. Method 200 may be implemented using first client device 130 embodied by computing device 300 as described in more detail below with respect to FIG. 3. First client device 130 may be disposed within and may be associated with a vehicle for example. Ways to implement the stages of method 200 will be described in greater detail below.

Method 200 may begin at starting block 205 and proceed to stage 210 where first client device 130 may report a position of first client device 130 (and thus a vehicle associated with first client device 130) to a cloud-based service through an Out-of-band (OOB) connection. First client device 130 may provide an IEEE 802.11 interface For example, the vehicle may have the following components associated with it: i) an IEEE 802:11 interface (to establish connectivity and roam); ii) an OOB low-rate connection (e.g., 3g/4g/5g); iii) Global Positioning System (GPS) or a similar positioning systems; and iv) other sensors (e.g., inertial, etc). A number of warless services (e.g., manufacturer via an established trust to the vehicle manufacturer.

Consistent with embodiments of the disclosure, when moving, a vehicle may report its position to the cloud-based service through the OOB connection periodically. The cloud-based service may be operated by the vehicle manufacturer for example. The vehicle, through first client device 130, may also report to the cloud-based service its intended path, if the driver has set the path in the vehicle’s navigation system or if the path has been predicted by the vehicle’s navigation system from common driving patterns of the driver.

From stage 210, where first client device 130 reports the position of first client device 130 to the cloud-based service through the OOB connection, method 200 may advance to stage 220 where first client device 130 may receive, from the cloud-based service, a mapping of services available to first client device 130. For example, if wireless services are available along the short-term (or whole) path of the vehicle, then the cloud-based service may provide a mapping of the available services to the vehicle, either over the OOB connection or over the first service connection via Wi-Fi. Such mapping may be augmented with the availability of: GPS location of APs/coverage area, Service Set Identifier (SSID), Basic Service Set Identifier (BSSID), and Band/Channel.

In another embodiment, the cloud-based service may provide the vehicle such information only when the vehicle is reaching the coverage area (e.g., real time, versus preloaded). For example, as the vehicle comes close to the coverage area of any wireless service, the cloud-based service starts (1) associating, (2) authenticating, and (3) establishing key material with the wireless deployment that provides such coverage. Once these steps are done, the cloud-based service may provide association, authentication, and key details to the vehicle via the OOB connection. In this way, the cloud-based service may implement the control-plane for the vehicle, leaving data-plane to the vehicle’s IEEE 802.11 interface (e.g., first client device 130).

Once first client device 130 receive, from the cloud-based service, the mapping of services available to first client device 130 in stage 220, method 200 may continue to stage 230 where first client device 130 may communicate according to the mapping of services available to first client device 130. Consistent with embodiments of the disclosure, the cloud-based service may implement control-plane functions and first client device 130 may implement data-plane functions. For example, the vehicle and the AP in the wireless service may start communicating. In a variation of this, if “roaming” from a wireless-service to another, the vehicle may be provided such association/authentication/key details through the current wireless-service connection from the cloud-based service. In another embodiment, the vehicle may also be given details about the different Media Access Control (MAC) addresses it may use and timestamps of when it will be able to use the wireless-service with those addresses.

Consistent with embodiments of the disclosure, the vehicle’s Layer 2 (L2) traffic may be tunneled to a common trusted anchor point, for example, at the vehicle manufacturer’s network where traffic may be centrally switched. In a variation of this, an Internet Protocol (IP) address may also be provided by the wireless-service on the road and then traffic may be switched locally at each location along the path.

Yet another embodiment may comprise connectivity to other vehicles via an ad-hoc quick mesh. For example, if the cloud-based service of the vehicle manufacturer knows that another close-by vehicle is following the same or similar path, the vehicle may be instructed to use the close-by vehicle to obtain connectivity via an ad-hoc quick mesh. In another embodiment, the cloud-based service may also perform Access Network Query Protocol (ANQP) operations with wireless services along-the-road, in order to start OpenRoaming operations, if this is supported.

In another embodiment, the cloud-based service may pre-calculate the amount of time the vehicle is expected to stay within the coverage area of a given AP given the navigation information such as route, traffic, and sensor information such as camera information about traffic signals in order to narrow down the list it provides to the vehicle. Once first client device 130 communicates according to the mapping of services available to first client device 130 in stage 230, method 200 may then end at stage 240.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing split Media Access Control (MAC) for automotive wireless as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
reporting, by a client device, a position of the client device to a cloud-based service through an Out-of-Band (OOB) connection;
receiving, by the client device from the cloud-based service, a mapping of services available to the client device; and
communicating, by the client device, according to the mapping of services available to the client device wherein the cloud-based service implements control-plane functions and the client device implements data-plane functions.

2. The method of claim 1, further comprising reporting, by the client device to the cloud-based service through the OOB connection, an intended path of the client device.

3. The method of claim 2, wherein the intended path of the client device is derived from a navigation system associated with the client device.

4. The method of claim 2, wherein the intended path of the client device is predicted based on past patterns of the client device.

5. The method of claim 1, wherein receiving the mapping of the services available to the client device comprises receiving the mapping of the services available to the client device when the client device reaches a coverage area of the services available to the client device.

6. The method of claim 1, wherein the mapping of the services available to the client device comprises different Media Access Control (MAC) addresses the client device will use and timestamps of when the client device will be able to use wireless-service associated with the different MAC addresses.

7. The method of claim 1, wherein communicating according to the mapping of services available to the client device comprises L2 traffic of the client device being tunneled to a common trusted anchor point.

8. The method of claim 1, further comprising receiving, from the cloud-based service, instructions for the client device to use a close-by client deice to obtain connectivity via an ad-hoc quick mesh.

9. The method of claim 1, wherein the cloud-based service performs Access Network Query Protocol (ANQP) operations with wireless services in order to start OpenRoaming operations.

10. The method of claim 1, wherein the client device comprises a vehicle.

11. A system comprising:
a memory storage; and
a processing unit disposed in a client device and coupled to the memory storage, wherein the processing unit is operative to:
report a position of the client device to a cloud-based service through an Out-of-Band (OOB) connection;
receive, from the cloud-based service, a mapping of services available to the client device; and
communicate according to the mapping of services available to the client device wherein the cloud-based service implements control-plane functions and the client device implements data-plane functions.

12. The system of claim 11, wherein the mapping of the services available to the client device comprises different Media Access Control (MAC) addresses the client device will use and timestamps of when the client device will be able to use wireless-service associated with the different MAC addresses.

13. The system of claim 11, wherein the processing unit is further operative to tunnel L2 traffic of the client device to a common trusted anchor point.

14. The system of claim 11, wherein the processing unit is further operative to receive, from the cloud-based service, instructions for the client device to use a close-by client deice to obtain connectivity via an ad-hoc quick mesh.

15. The system of claim 11, wherein the cloud-based service performs Access Network Query Protocol (ANQP) operations with wireless services in order to start OpenRoaming operations.

16. A non-transitory computer-readable medium that stores a set of instructions which when executed perform a method executed by the set of instructions comprising:
reporting, by a client device, a position of the client device to a cloud-based service through an Out-of-Band (OOB) connection;
receiving, by the client device from the cloud-based service, a mapping of services available to the client device; and
communicating, by the client device, according to the mapping of services available to the client device wherein the cloud-based service implements control-plane functions and the client device implements data-plane functions.

17. The non-transitory computer-readable medium of claim 16, further comprising reporting, by the client device to the cloud-based service through the OOB connection, an intended path of the client device.

18. The non-transitory computer-readable medium of claim 17, wherein the intended path of the client device is derived from a navigation system associated with the client device.

19. The non-transitory computer-readable medium of claim 17, wherein the intended path of the client device is predicted based on past patterns of the client device.

20. The non-transitory computer-readable medium of claim 17, wherein receiving the mapping of the services available to the client device comprises receiving the mapping of the services available to the client device when the client device reaches a coverage area of the services available to the client device.
